(19) United States
(12) Patent Application Publication
(10) Pub. No.: US 2017/0032362 A1
(43) Pub. Date: Feb. 2, 2017

(54) STREAMLINED ENROLLMENT OF CREDIT CARDS IN MOBILE WALLETS

(71) Applicant: CA, Inc., New York, NY (US)

(72) Inventors: RAJDEEP LAHKAR, Bangalore (IN); Mahesh Malatesh Chitragar, Bangalore (IN)

(73) Assignee: CA, Inc., New York, NY (US)

(21) Appl. No.: 14/815,222

(22) Filed: Jul. 31, 2015

(51) Int. Cl. G06Q 20/36; G06Q 20/32

(52) U.S. Cl. CPC G06Q 20/3672; G06Q 20/3255; G06Q 20/3674

(57) ABSTRACT

A method of enrolling a payment card in a mobile wallet app includes receiving, on a mobile device, a request from a user to enroll a financial account in a mobile wallet application installed on the mobile device, sending an enrollment request to a wallet server, the enrollment request including an identification string uniquely associated with the mobile device, receiving a payment token associated with the financial account from the wallet server, and notifying the user that the financial account has been enrolled into the mobile wallet application responsive to receipt of the payment token. Related computer program products are also disclosed.

### FIELD

The present disclosure relates to application programs for mobile computing devices. In particular, the present disclosure relates to mobile wallet applications that facilitate mobile payments using mobile computing devices.

### BACKGROUND

With the proliferation of mobile devices, the card payment industry is moving toward payment using mobile payment applications on mobile devices. Mobile payment applications, also referred to as mobile wallet applications or mobile wallet apps, are payment services that operate on a mobile device and that interact with point of sale terminals or kiosks to facilitate payment for goods or services.

One form of mobile payment involves credit card tokenization. In a system that uses credit card tokenization, a payment token that acts as a substitute for a Primary Account Number (PAN), such as a credit card number, is transmitted to a point of sale (POS) terminal. A payment token service provider may be authorized to provide payment tokens to token requestors, such as card on file merchants, acquirer processors, payment gateways, digital wallet providers, card issuers, and the like. The token service provider may be implemented to run on a server and to receive requests for payment tokens from one or more token requestors. For each payment token request, the token service provider generates a random payment token, which is in some cases a Bank Identification Number (BIN)/Issuer Identification Number (IIN) range that is not currently being used by any active payment card. The token may be given some expiration period and can be used in place of the PAN for a payment card until it expires.

The term “tokenization” thus refers to the process of generating a token from a sensitive data element, such as a PAN. De-tokenization is the reverse process of redeeming a token for its associated sensitive data element. For example, de-tokenization may refer to the process of obtaining a PAN corresponding to a token.

The “Europay, Mastercard and Visa” (EMV) consortium has defined specifications for mobile cards that work within a secure payment infrastructure. All major card brands, including Visa, Mastercard, American Express, Discover, etc., have developed card specifications that derive from the EMV specifications.

### SUMMARY

A method of enrolling a payment card in a mobile wallet app includes receiving, on a mobile device, a request from a user to enroll a financial account in a mobile wallet application installed on the mobile device, sending an enrollment request to a wallet server, the enrollment request including an identification string uniquely associated with the mobile device, receiving a payment token associated with the financial account from the wallet server, and notifying the user that the financial account has been enrolled into the mobile wallet application responsive to receipt of the payment token.

The method may further include sending a device ID request to the wallet server requesting assignment of a device ID that is uniquely associated with the mobile device by the wallet server, and receiving the device ID from the wallet server, wherein the enrollment request includes the device ID.

The enrollment request and the device ID request may be sent over different networks. In particular, the device ID request may be sent over a TCP/IP based network, and the enrollment request is sent over a short message service (SMS) network.

The identification string associated with the mobile device may include a telephone number assigned to the mobile device, and sending the enrollment request may include sending a short message service (SMS) message from the mobile wallet application to the wallet server.

The method may further include receiving a request from the wallet server for authentication of the enrollment request by the user, requesting the user to input authentication information, receiving the authentication information from the user, and transmitting the authentication information to the wallet server. The authentication information may include a personal identification number associated with the financial account.

The method may further include generating the device ID, and including the device ID in the enrollment request.

The enrollment request may not include an account number of the financial account.

A method of enrolling a payment card in a mobile wallet app by a wallet server includes receiving an enrollment request from a mobile wallet application to enroll a financial account in the mobile wallet application. The enrollment request may include a device ID that is associated with a mobile device on which the mobile wallet application is installed and an identification string uniquely associated with the mobile device on which the mobile wallet application is installed. The method further includes associating the device ID with the identification string, sending a request for account information to an issuer server, and receiving account information from the issuer server. A payment token that is usable by the mobile wallet application for initiating a transaction using the financial account is generated from the account information, and the payment token is sent to the mobile wallet application. The enrollment request may not include an account number of the financial account.

The account information may include account information for a plurality of financial accounts, and generating the payment token may include generating a plurality of payment tokens corresponding to the plurality of financial accounts. The account information may include Europay Mastercard Visa (EMV) data.

The account information received from the issuer server may include a cryptographic key that is camouflaged using a personal identification number associated with the financial account.

The method may include receiving a request to generate the device ID, generating the device ID in response to the request to generate the device ID, and transmitting the device ID to the mobile wallet application.

The method may include receiving an authentication request from the issuer server requesting authentication of the mobile device, transmitting the authentication request to the mobile wallet application, receiving authentication data from the mobile wallet application, and transmitting the authentication data to the issuer server.

Some embodiments may take the form of a computer program product including a tangible computer readable storage medium having computer readable program code embodied in the medium.

It is noted that aspects described herein with respect to one embodiment may be incorporated in different embodiments although not specifically described relative thereto. That is, all embodiments and/or features of any embodiments can be combined in any way and/or combination. Moreover, other systems, methods, and/or computer program products according to embodiments will be or become apparent to one with skill in the art upon review of the following drawings and detailed description. It is intended that all such additional systems, methods, and/or computer program products be included within this description, be within the scope of the present disclosure, and be protected by the accompanying claims.

### BRIEF DESCRIPTION OF THE DRAWINGS

Aspects of the present disclosure are illustrated by way of example and are not limited by the accompanying figures.

FIG. 1 is a block diagram illustrating a system including a mobile device on which a mobile wallet app is installed, a wallet server and an issuer server.

FIG. 2 is a flow diagram illustrating message flows according to some embodiments between a mobile device, a mobile wallet app, a wallet server and an issuer server.

FIG. 3 is a block diagram of a wallet server according to some embodiments.

FIG. 4 is a block diagram of a user terminal according to some embodiments.

FIGS. 5-7 are flowcharts illustrating systems/methods according to various embodiments.

FIG. 8-10 are flow diagrams illustrating message flows according to further embodiments between a mobile device, a mobile wallet app, a wallet server and an issuer server.

FIG. 11 is a block diagram illustrating the use of a mobile wallet app to conduct a financial transaction.

### DETAILED DESCRIPTION

Embodiments of the present disclosure will be described more fully hereinafter with reference to the accompanying drawings. Other embodiments may take many different forms and should not be construed as limited to the embodiments set forth herein. Like numbers refer to like elements throughout.

For simplicity, the following discussion will be limited to a description of point of sale purchases. However, the description is equally applicable to ATM and similar transactions.

One hindrance to the widespread adoption of mobile wallet apps is the amount of effort it requires for a user to enroll a payment card, such as a credit card or debit card, in the mobile wallet application. Typically, to enroll a payment card in a mobile wallet app, a user must open the mobile wallet app, click on an enroll button and enter a credit card number, expiration date, cardholder name, and security code, or CVVN code. This requires a substantial amount of interaction by the user. Some embodiments of the inventive concepts described herein enable a user to enroll a payment card in a mobile wallet app with a substantially reduced amount of user interaction. In some embodiments, a user may be required to only perform a single action, such as a single button press or single click, to enroll a payment card in a mobile wallet app.

In some embodiments, payment card enrollment is performed by a mobile wallet app that communicates with a wallet server. The wallet server communicates with the mobile wallet app and an issuer server. The wallet server identifies the user of a mobile wallet app based on a unique number associated with the mobile wallet app. For example, the unique number may be a telephone number assigned to a mobile device on which the mobile wallet app is running. Using the unique number, the wallet server can obtain payment information from an issuer server that is also aware of the unique number. The wallet server can generate a payment token from the payment information, and provide the payment token to the mobile wallet app. The payment token can then be used by the mobile wallet app to conduct transactions.

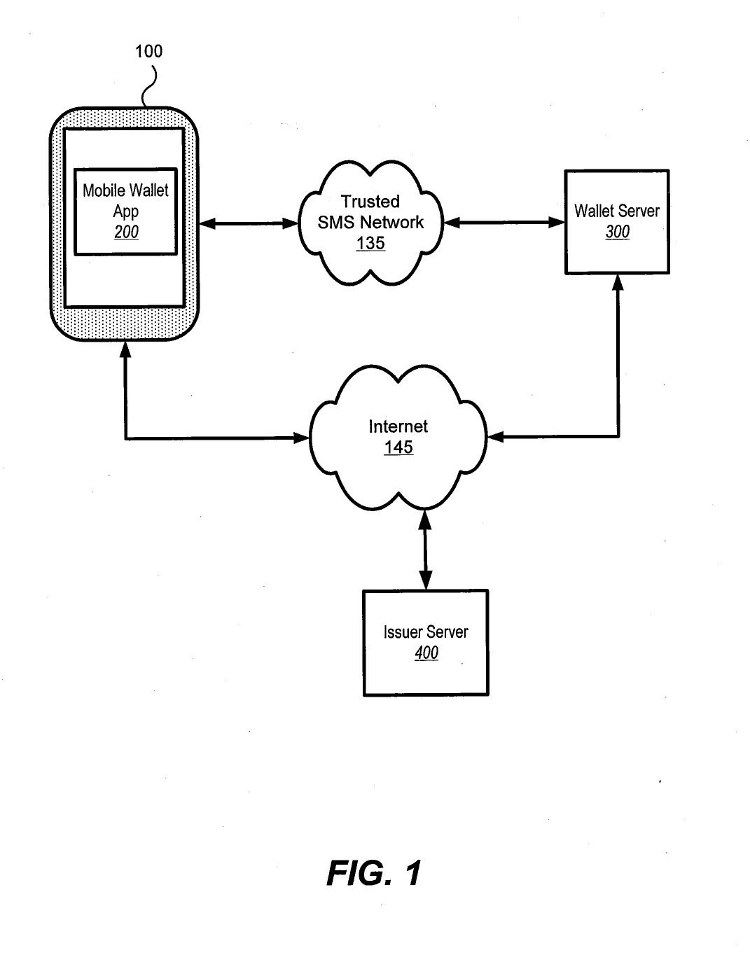

Referring to FIG. 1, a mobile wallet app 200 is installed and operates on a mobile computing and communication device 100, such as a mobile phone. The mobile wallet app 200 communicates with a remote wallet server 300 over a trusted SMS network 135, such as an SMS network operated by a mobile carrier. The mobile wallet app 200 may also communicate with the wallet server 300 over a data communication network 145, such as the Internet. The mobile device 100 may be configured to communicate wirelessly over the trusted SMS network 135 and the data communication network 145. The wallet server 300 may also communicate over the data communication network 145 with an issuer server 200 that is operated by a payment card issuer. The issuer server 200 has access to payment card information for payment cards issued by the card issuer. Such information may include primary account numbers (PANs), as well as information associated with the card holder, such as name, address, telephone number, and a personal identification number (PIN).

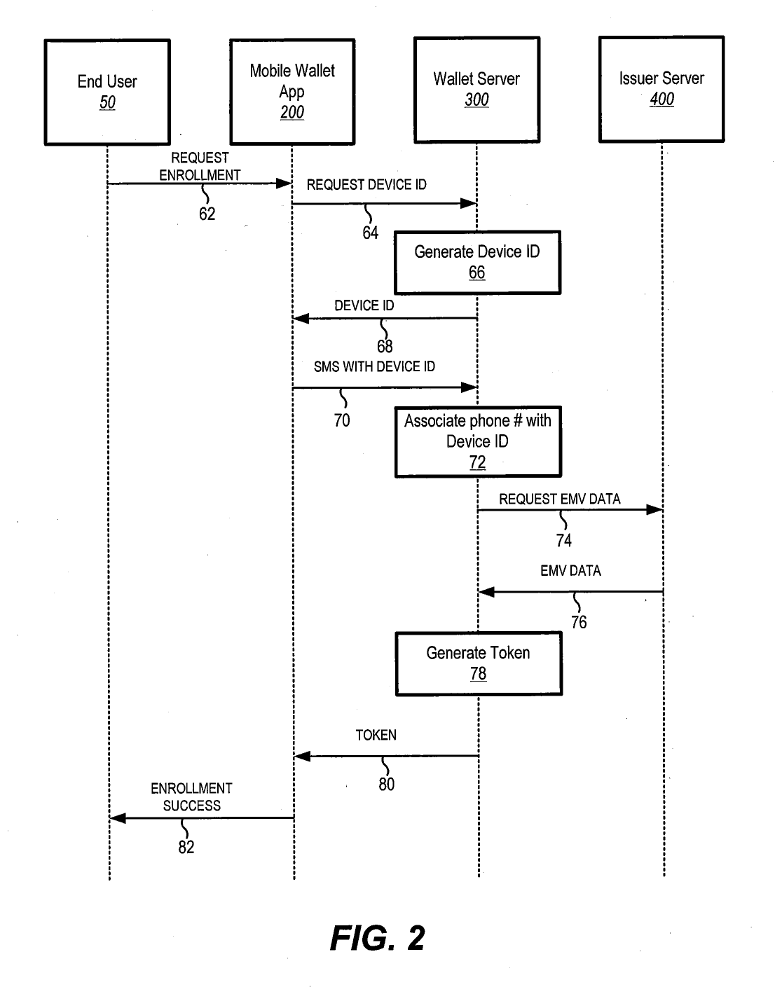

Simplified enrollment of payment cards in the mobile wallet app 200 according to some embodiments is illustrated in FIG. 2. FIG. 2 illustrates various messages that are communicated between the mobile wallet app 200, the wallet server 300 and the issuer server 400.

Referring to FIG. 2, an end user 50 of a mobile wallet app 200 requests 62 that the mobile wallet app 200 enroll the user's payment cards in the mobile wallet app 300. The user 50 may communicate this request to the mobile wallet app by, for example, selecting an appropriate button or menu option in the app, e.g., by tapping on a touchscreen. In some embodiments, this action may be the only user action required for the enrollment to complete.

Next, the mobile wallet app 200 connects 64 to the wallet server 300 to obtain a unique device ID for the mobile device 100. The wallet server 300 generates the unique device ID for the mobile device 100 (block 66) and transmits 68 the device ID to the mobile wallet app 200. Both the wallet server 300 and the mobile wallet app 200 may store this unique device ID for use in identifying subsequent client/server calls.

Next, the mobile wallet app 200 transmits an enrollment request message 70 over a trusted network to the wallet server 300. For example, the mobile wallet app 200 may transmit the enrollment request message 70 over an SMS service operated by a wireless communication carrier. Note that the enrollment request and the device ID request may be sent over different networks. In particular, the device ID request may be sent over a TCP/IP based data communication network 145, while the enrollment request may be sent over a short message service (SMS) network 135 that is operated by a public carrier. The enrollment request may not, however, include any payment information, such as credit card numbers, account numbers, etc.

The enrollment request message contains the device ID provided by the wallet server 300. In addition, because the enrollment request message 70 is transmitted over a trusted SMS network, the wallet server 300 is able to determine the telephone number of the mobile device 100 from which the message was sent. The wallet server 100 therefore has confidence that the enrollment request message was actually sent from the mobile device 100 associated with the device ID provided in the enrollment request message.

In other embodiments, a different unique number may be provided to the wallet server 300 along with the device ID, such as an International Mobile Subscriber Identity (IMSI), or International Mobile Station Equipment Identity (IMEI) associated with the mobile device 100.

The wallet server 300 parses the SMS message containing the enrollment request message to obtain the device ID contained in the request and the unique number associated with the mobile device 100. That is, the wallet server 300 obtains the unique number from a trusted source, namely, the operator of the trusted SMS network 135.

In some embodiments, the wallet server 300 may have already associated the device ID with the unique number. In that case, the wallet server 300 may confirm that the device ID and the unique number are correct, i.e., that the device ID is the correct ID for the mobile device identified by the unique number (block 72). If the device ID is not already associated with a unique number, the wallet server may associate the device ID and the unique number in block 72.

The wallet server 300 may then send one or more requests 74 to one or more issuer servers 400 that are operated by payment card issuers to obtain credit card data, such as EMV data, associated with the unique number. The requests 114 may be sent over the data communication network 145 using an appropriate application programming interface (API) for the payment card issuer. The payment information may, for example, be EMV data that can be provided by an issuer. The EMV data may contain a crypto key (that is used to conduct payments) that has been camouflaged using a PIN associated with the payment card. Cryptographic camouflaging is described, for example, in U.S. Publication No. 2011/0060913, the disclosure of which is incorporated herein by reference. Essentially, cryptographic camouflage operates by carefully encrypting the financial key in a manner such decrypting the key with any possible PIN will reveal a valid-looking key, with no error report. Only by attempting a transaction will an attacker find out if the correct PIN has been guessed. The card issuer can lock the account after a pre-set number of attempts, thus nullifying the brute-force attack.

The issuer server 400 retrieves the user's payment information based on the telephone number provided by the wallet server 300 and transmits 116 the payment information to the wallet server 300. Since the user's telephone number is provided from a trusted source, namely the wallet server 300, the issuer server 400 may have confidence that the user's identity has been established.

Once the wallet server 300 receives the payment information from the issuer server 400, the wallet server 300 generates a payment token (block 78) for each payment card for which payment information was received. The wallet server 300 sends the payment token 80 to the mobile wallet app 200 to be provisioned on the mobile device 100. It will be appreciated that the actual primary account number (e.g., credit card number) is not stored on the mobile device 100.

The mobile wallet app 200 then notifies 82 the user 50 that the registration process is complete. At this point, the mobile wallet app 200 has all the required information to perform financial transactions using the registered payment cards.

To execute a payment transaction, the user 50 would open the mobile wallet app 200 and select desired payment card from among the payment cards registered on the mobile wallet app 200. The mobile wallet app 200 would then prompt the user to enter a PIN associated with the selected payment card. With this PIN, the mobile wallet app 200 app would de-camouflage the crypto key and use the de-camouflaged crypto key to complete the payment. The correct crypto key would be obtained only if the user enters the correct PIN, and payment would be successful only if the crypto key is correct. Thus, even if camouflaged crypto key were somehow obtained from the mobile device, the crypto key could not be used to conduct a transaction even if a brute force attempt to de-camouflage the key were attempted.

Some embodiments validate a user's telephone number using a trusted source, such as an SMS telecom service provider and obtain payment information directly from the user's bank using the telephone number.

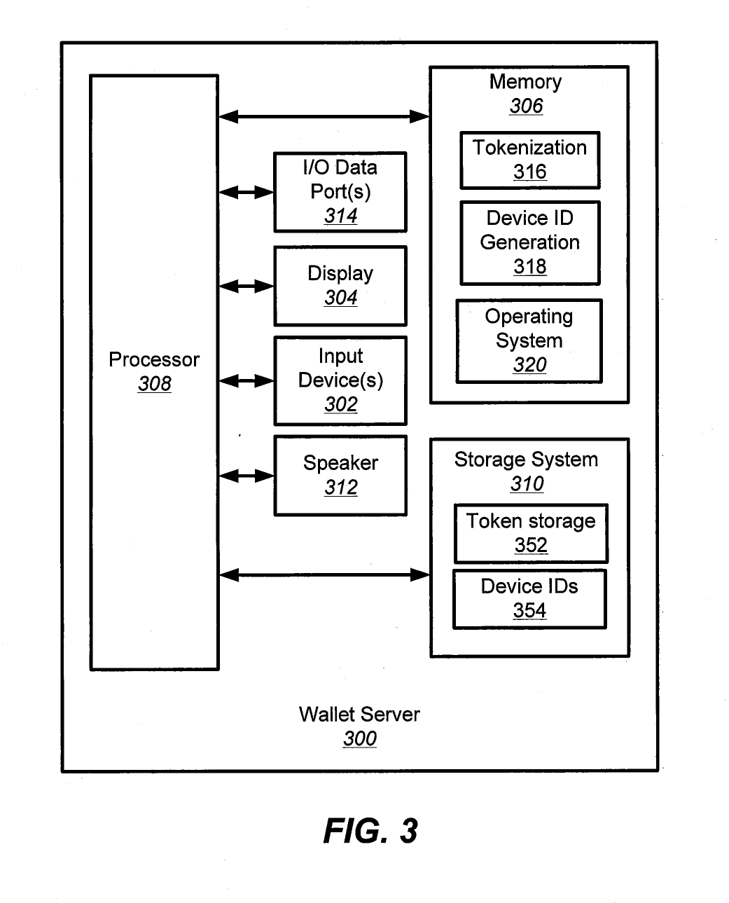

FIG. 3 illustrates aspects of a wallet server 300 according to some embodiments. The wallet server 300 includes a processor 308 that communicates with a memory 306, a storage system 310, and one or more I/O data ports 314. The wallet server 300 may also include a display 304, an input device 302 and a speaker 312. The memory 306 stores program instructions and/or data that configure the wallet server 300 for operation. In particular, the memory 306 may store a tokenization module 316, a device ID generation module 318 and an operating system 320. The tokenization module 316 tokenizes the payment information provided by the issuer server 400, while the device ID generation module 318 generates a unique device ID in response to a request by a mobile wallet app.

The storage system 310 may include, for example, a hard disk drive or a solid state drive, and may include a token storage 352 that stores tokens generated by the tokenization module 316. The storage system 310 may also include a device ID storage 354 that stores device IDs generated by the device ID generation module 318.

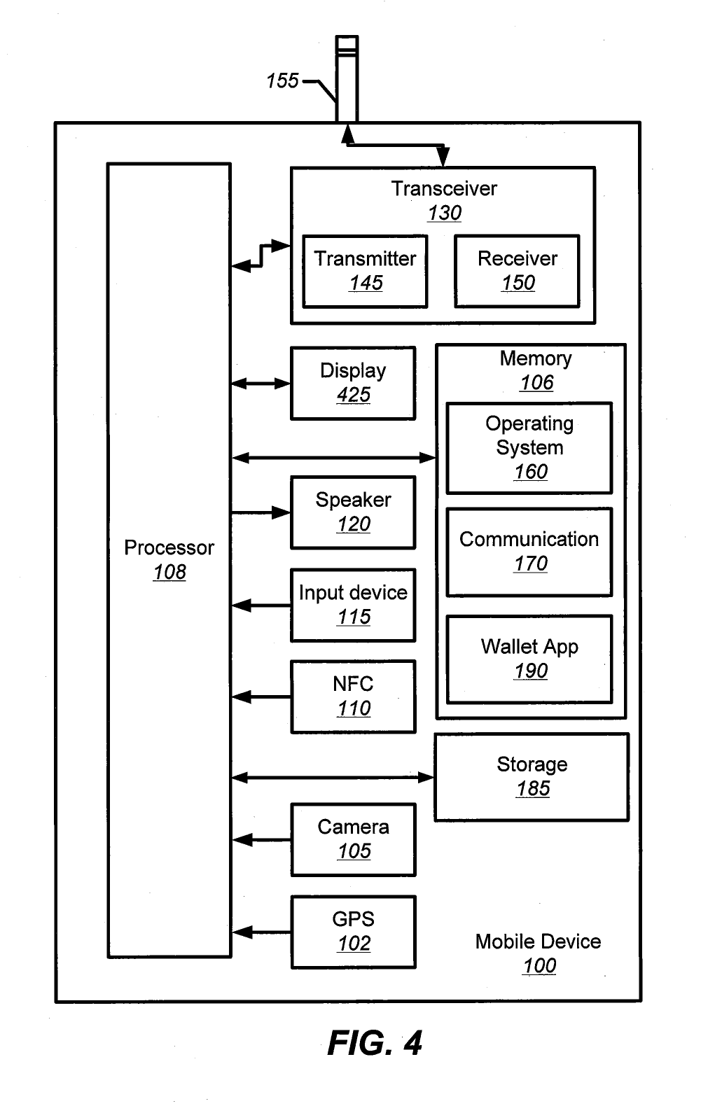

A mobile device 100 according to some embodiments is illustrated in FIG. 4. The mobile device 100 includes a processor 108 that communicates with a memory 106, a storage 185, and a transceiver 130. The transceiver 130 is coupled to an antenna 155 and includes a transmitter 145 and a receiver 150 that enable the mobile device 100 to communicate over one or more wireless data networks, such as WCDMA, 3G LTE, Wifi, and the like. It will be appreciated that a separate Wifi transceiver, Bluetooth transceiver, or other transceiver may also be included in the mobile device 100. The mobile device 100 may also include a display 125, one or more input devices 115, such as a keypad, touchscreen and/or microphone, a speaker 120, a near field communications (NFC) module 110, a camera 105 and a GPS receiver 102. The memory 106 stores program instructions and/or data that configure the mobile device 100 for operation. In particular, the memory 106 may store an operating system 160, a communication module 170, and a mobile wallet app 190. The storage 185 may store tokens and/or a device ID provided by the wallet server 300.

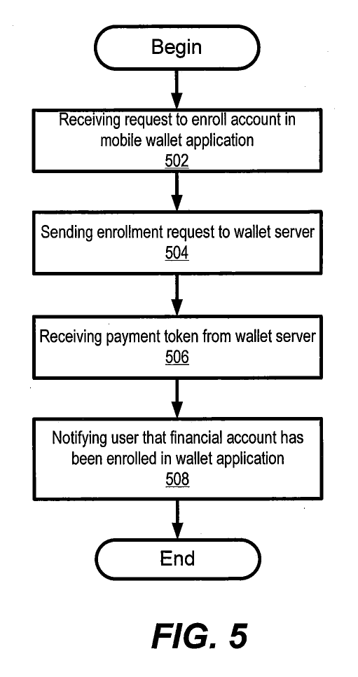

Systems/methods according to some embodiments are illustrated in FIG. 5, which is a flowchart of operations that may be performed by a mobile wallet app 200 installed on a mobile device 100 that is configured according to some embodiments. Referring to FIG. 5, a mobile wallet app 200 may receive a request from a user 50 to enroll the user's financial accounts in the mobile wallet app (block 502). In response, the mobile wallet app 200 sends an enrollment request to a wallet server 300 (block 504). The mobile wallet app 200 then receives one or more payment tokens from the wallet server 300 (block 508) and notifies the user that the financial accounts associated with the one or more payment tokens have been successfully enrolled in the mobile wallet app (block 508).

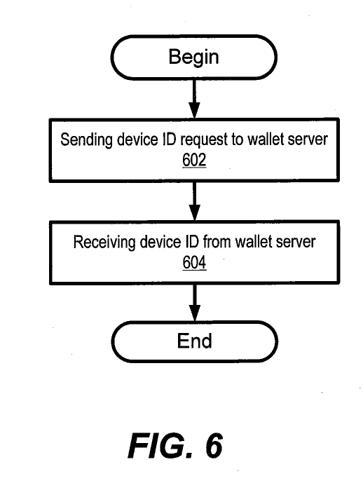

FIG. 6 illustrates additional operations of a mobile wallet app 200. Referring to FIG. 6, the mobile wallet app 200 may send a device ID request to the wallet server 300 (block 602). The device ID request may be sent before, or concurrently with, an enrollment request. The mobile wallet app 200 then receives a device ID from the wallet server, and stores the device ID in the storage 185.

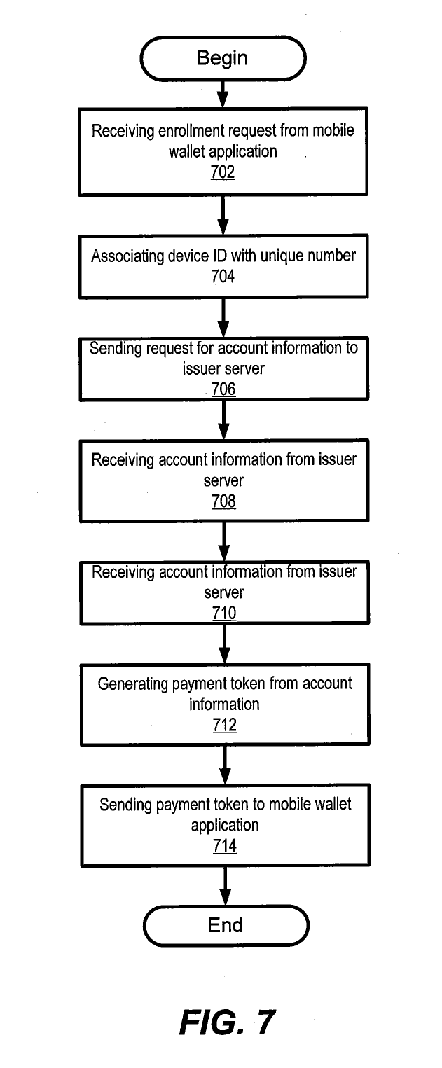

FIG. 7 illustrates operations of a wallet server 300 that is configured according to some embodiments. Referring to FIG. 7, the wallet server 300 receives an enrollment request from a mobile wallet app 200 (block 702). The enrollment request may include a device ID associated with the mobile device 100 on which the mobile wallet app 200 is installed, or a request to assign a device ID. The wallet server 300 may parse the request to obtain a unique number associated with the mobile device 100, such as a telephone number associated with the mobile device 100.

The wallet server 300 associates the device ID of the requesting device with the unique number (block 704) and sends a request for account information to the issuer server 400 along with the unique number (block 706). The wallet server 300 may send the request to one or more issuer servers belonging to different payment card issuers.

The wallet server 300 then receives payment account information from the issuer servers (block 710) and generates payment tokens from the account information (block 712). Finally, the wallet server 300 sends the payment tokens to the mobile wallet app 200 (block 714).

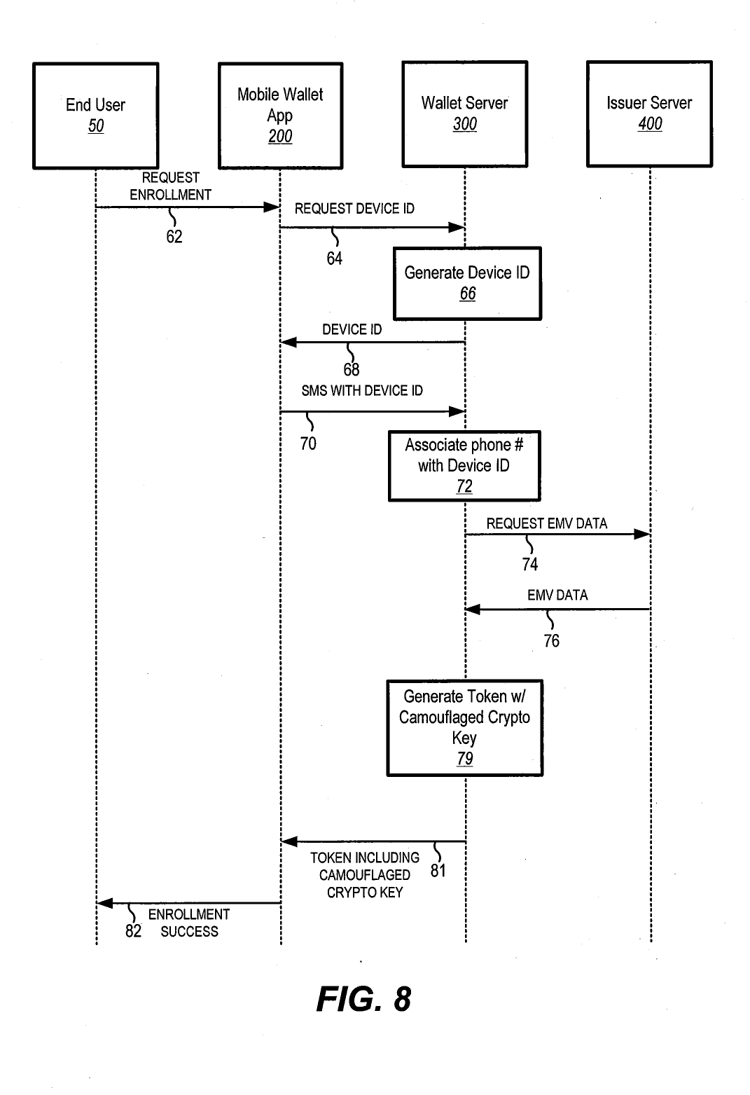

FIGS. 8-10 illustrate message flows according to various other embodiments. Some messages/operations illustrated in FIGS. 8-10 are similar to those illustrated in FIG. 2, and a detailed explanation of those messages/operations will not be repeated. Referring to FIG. 8, in some embodiments, after receiving the EMV data, the wallet server 300 generates a payment token and camouflages the cryptographic key in the payment token using the key camouflage techniques described above (block 79). The payment token including the camouflaged crypto key is then sent 81 to the mobile wallet app 200. Operations then proceed as illustrated in FIG. 2.

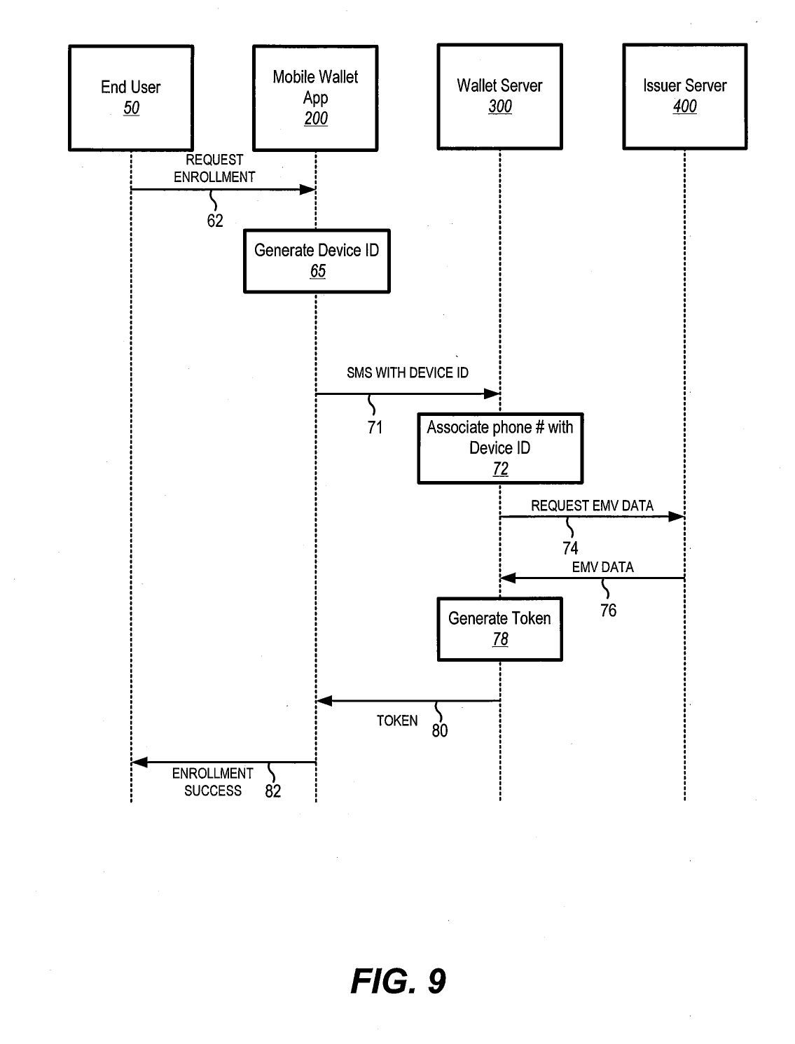

Referring to FIG. 9, the mobile wallet app 200 generates a unique device ID (block 65) and sends 71 the unique device ID to the wallet server 300 along with the enrollment request. Operations then proceed as illustrated in FIG. 2.

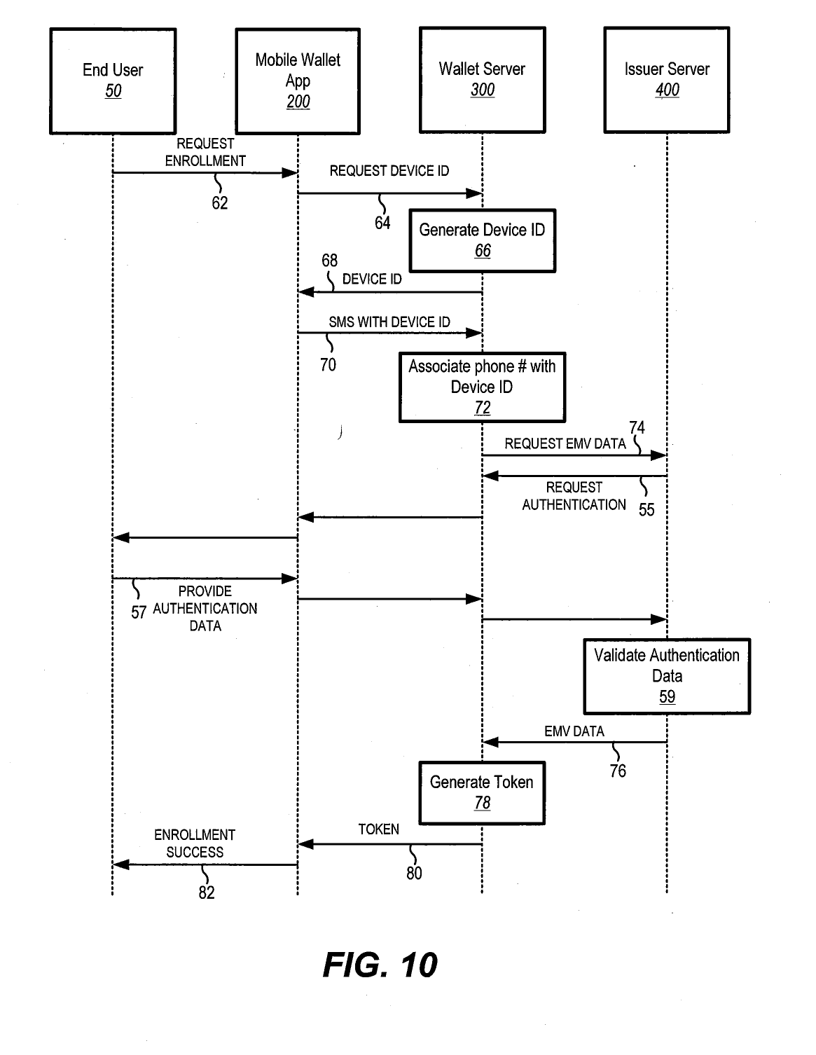

In some embodiments, additional authentication may be required by the issuer server. For example, referring to FIG. 10, after the wallet server 300 sends a request for payment account (EMV) data to the issuer server 400 at message 74, the issuer server may respond with a request 55 for additional authentication from the user. The wallet server 300 may forward the request to the mobile wallet app 200, which prompts the user 50 to provide authentication data. The authentication data may include, for example, a PIN number associated with the payment account, a password, or other authentication data.

The user 50 submits 57 the authentication data to the mobile wallet app 200, which forwards the data to the wallet server 300. The wallet server 300 then provides the authentication data to the issuer server 400, which validates the authentication data (block 59). If the authentication data is valid, the issuer server 400 provides 76 the EMV data to the wallet server 300, and operations proceed as described with respect to FIG. 2.

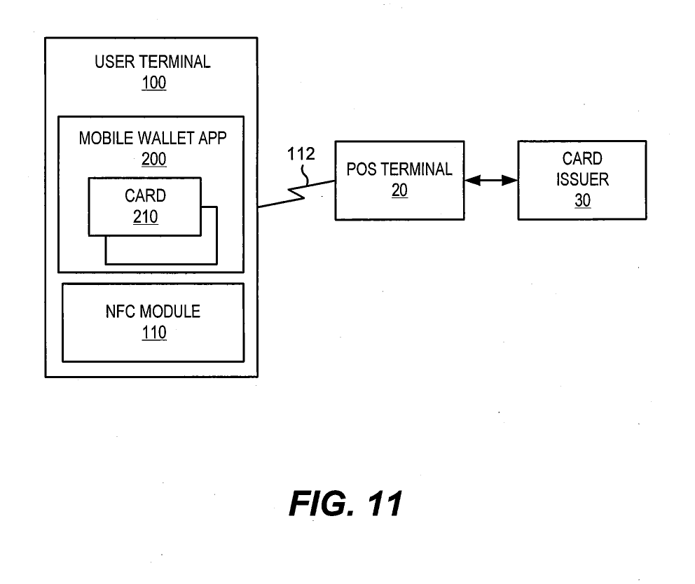

FIG. 11 illustrates the use of a mobile wallet app 200 to conduct a financial transaction, such as a POS purchase. Referring to FIG. 11, a user terminal 100 includes a mobile wallet app 200 that stores electronic payment credentials, i.e. “cards” 210 in a memory of the terminal 100, and an NFC module 110. The NFC module may include a transceiver and associated software and/or firmware that enables the user terminal 100 to engage in NFC communications.

A mobile device may use near field communications (NFC) instead of the physical electrical contact used for a card to communicate with a POS terminal. Near field communication (NFC) is a set of standards that enable short-range, bidirectional wireless communication between devices by touching them together or bringing them into close proximity, usually no more than a few inches. NFC standards cover communications protocols and data exchange formats, and are based on existing radio-frequency identification (RFID) standards.

To use the NFC-enabled user terminal 100 to conduct a transaction, the mobile device 100 may be placed against (or close to) the POS terminal 20 for several seconds, during which time a wireless NFC communication path 112 is established between the mobile device 100 and the POS terminal 20. The transaction may be negotiated between the card 110 and the POS terminal using the wireless communication path 112.

Other types of wireless communication protocols, such as Bluetooth and Wi-Fi may be used to establish the wireless communication path 112.

As noted above, the electronic payment credentials in the card 110 may include cryptographic keys that are used to digitally sign transaction data for verification/authentication purposes. For security purposes, it is generally not desirable to store this sensitive data in a normal memory that may be subject to tampering or hacking. Instead, cards are typically stored within a “Secure Element” (SE), which is a tamper-resistant chip that provides secure data storage along with a cryptographic microprocessor to facilitate transaction authentication and security, and provide secure memory for storing payment applications. Payment applications can also run within the Secure Element.

To conduct a transaction, a user may select a card 210 from among a plurality of cards stored in the mobile wallet app 200 of the user terminal 100. The customer may then hold the user terminal 100 near the merchant POS terminal 20. The POS terminal 20 and the user terminal 100 start a session where they communicate over an NFC interface 112. The card 210 and the POS terminal 20 exchange messages according to the EMV protocol. Included in these messages is data identifying the card (card data), data identifying the terminal (terminal data), other transaction data, and data output by transaction algorithms running on the POS terminal 20 and the card 210. The card data may include, for example, the Primary Account Number (PAN) of the card 210, the cardholder name, expiration date, etc. The terminal data may include a terminal country code, etc. The other transaction data may include the date, transaction type, transaction amount, etc. The card data, the terminal data and/or the other transaction data, or any portions of these items, can be referred to generally as “transaction data.”

Using the transaction data, the mobile wallet app 200 and the POS terminal 20 negotiate the manner in which the transaction will proceed. The POS terminal 20 may use the transaction data to authorize the transaction with the card issuer 30.

In the process of conducting the transaction, the mobile wallet app 200 may generate a cryptogram, which is an encrypted message that is a form of transaction digest that can be used to authenticate the transaction to the card issuer 30. The cryptogram is generated by encoding transaction data using a cryptographic key stored in the user terminal 100.

The cryptographic keys, or “financial keys” may include, in some embodiments, keys of the form: a symmetric key (such as a 3DES key or an Advanced Encryption Standard (AES) key), a secret, a secret byte array, a seed, and/or a controlled datum.

For cryptogram generation, early versions of EMV used a single financial key, or cryptogram key (CK), which is a 16 byte key (composed of two DES keys). The relevant data is combined, hashed, and encrypted using the CK, to form the cryptogram.

Later versions of EMV use a 16 byte “Application Cryptogram Master Key” (MK), and from that generate a 16 byte “Application Cryptogram Session Key” (SK), for each transaction. The session key is a secret item that is stored in the card. The session key, which is different for every transaction, is used to generate a cryptogram in much the same way as the original CK was used. There are several different algorithms in use for generating a session key from a master key.

A cryptogram is typically an 8 byte value that can be understood as a signature on transaction data. The mobile wallet app 200 generates the cryptogram by encoding the transaction data with the cryptographic key 120 using a hash function that takes the transaction data and the cryptographic key as inputs and generates the cryptogram as an output. The hash function used to generate the cryptogram is a one-way mathematical function. That is, the cryptographic key and the transaction data cannot be recovered from the cryptogram. Also, the cryptogram is unique to the particular transaction data and cryptographic key that are used.

Thus, assuming the card issuer 30 knows the cryptographic key used by the card 210, once the card issuer 30 has been provided the transaction data by the POS terminal 20, the card issuer can verify that the card 210 generated the cryptogram by generating the cryptogram from the transaction data using the known cryptographic key and comparing it to the cryptogram that was generated by the card 210.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a buffered repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as JavaScript, Scala, Smalltalk, Eiffel, JADE, Emerald, C++, C#, VaNET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable storage medium that when executed can direct a computer, other programmable data processing apparatus, or other devices to function in a particular manner, such that the instructions when stored in the computer readable storage medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
performing operations as follows on a processor of a mobile device:
receiving, on a mobile device, a request from a user to enroll a financial account in a mobile wallet application installed on the mobile device;
sending an enrollment request to a wallet server, the enrollment request including an identification string uniquely associated with the mobile device;
receiving a payment token associated with the financial account from the wallet server; and
notifying the user that the financial account has been enrolled into the mobile wallet application responsive to receipt of the payment token.

2. The method of claim 1, further comprising:
sending a device ID request to the wallet server requesting assignment of a device ID that is uniquely associated with the mobile device by the wallet server; and
receiving the device ID from the wallet server;
wherein the enrollment request includes the device ID.

3. The method of claim 2, wherein the enrollment request and the device ID request are sent over different networks.

4. The method of claim 3, wherein the device ID request is sent over a TCP/IP based network, and wherein the enrollment request is sent over a short message service (SMS) network.

5. The method of claim 1, wherein the identification string associated with the mobile device comprises a telephone number assigned to the mobile device, and wherein sending the enrollment request comprises sending a short message service (SMS) message from the mobile wallet application to the wallet server.

6. The method of claim 1, further comprising:
receiving a request from the wallet server for authentication of the enrollment request by the user;
requesting the user to input authentication information;
receiving the authentication information from the user; and
transmitting the authentication information to the wallet server;

7. The method of claim 6, wherein the authentication information comprises a personal identification number associated with the financial account.

8. The method of claim 1, further comprising:
generating the device ID; and
including the device ID in the enrollment request.

9. The method of claim 1, wherein the enrollment request does not include an account number of the financial account.

10. A method, comprising:
performing the following operations on a processor of a wallet server:
receiving an enrollment request from a mobile wallet application to enroll a financial account in the mobile wallet application, wherein the enrollment request comprises a device ID that is associated with a mobile device on which the mobile wallet application is installed and an identification string uniquely associated with the mobile device on which the mobile wallet application is installed;
associating the device ID with the identification string;
sending a request for account information to an issuer server;
receiving account information from the issuer server;
in response to receiving the account information, generating from the account information a payment token that is usable by the mobile wallet application for initiating a transaction using the financial account; and
sending the payment token to the mobile wallet application.

11. The method of claim 10, wherein the enrollment request does not include an account number of the financial account.

12. The method of claim 10, wherein the account information comprises account information for a plurality of financial accounts, and wherein generating the payment token comprises generating a plurality of payment tokens corresponding to the plurality of financial accounts.

13. The method of claim 10, wherein the account information comprises Europay Mastercard Visa (EMV) data.

14. The method of claim 10, wherein the account information received from the issuer server comprises a cryptographic key that is camouflaged using a personal identification number associated with the financial account.

15. The method of claim 10, further comprising:
before receiving the enrollment request, receiving a request to generate the device ID;
generating the device ID in response to the request to generate the device ID; and
transmitting the device ID to the mobile wallet application.

16. The method of claim 10, further comprising:
receiving an authentication request from the issuer server requesting authentication of the mobile device;
transmitting the authentication request to the mobile wallet application;
receiving authentication data from the mobile wallet application; and
transmitting the authentication data to the issuer server.

17. A computer program product for enrolling a financial account in a mobile wallet application, the computer program product comprising:
a tangible computer readable storage medium having computer readable program code embodied in the medium, the computer readable program code comprising:
computer readable program code configured to receive, on a mobile device on which the mobile wallet application is installed, a request from a user to enroll the financial account in the mobile wallet application;
computer readable program code configured to send an enrollment request to a wallet server, the enrollment request including an identification string uniquely associated with the mobile device;
computer readable program code configured to receive a payment token associated with the financial account from the wallet server; and
computer readable program code configured to notify the user that the financial account has been enrolled into the mobile wallet application.

18. The computer program product of claim 17, further comprising:
computer readable program code configured to send a device ID request to the wallet server requesting assignment of a device ID that is uniquely associated with the mobile device by the wallet server; and
computer readable program code configured to receive the device ID from the wallet server

19. A computer program product for enrolling a financial account in a mobile wallet application, the computer program product comprising:
a tangible computer readable storage medium having computer readable program code embodied in the medium, the computer readable program code comprising:
computer readable program code configured to receive an enrollment request from a mobile wallet application to enroll a financial account in the mobile wallet application, wherein the enrollment request comprises a device ID that is associated with a mobile device on which the mobile wallet application is installed and an identification string uniquely associated with the mobile device on which the mobile wallet application is installed;
computer readable program code configured to associate the device ID with the identification string;
computer readable program code configured to send a request for account information from an issuer server associated with financial account;
computer readable program code configured to receive account information from the issuer server;
computer readable program code configured to generate from the account information a payment token that is usable by the mobile wallet application for initiating a transaction using the financial account; and
computer readable program code configured to transmit the payment token to the mobile wallet application.

20. The computer program product of claim 19, further comprising:
computer readable program code configured to receive a request to generate the device ID;
computer readable program code configured to generate the device ID in response to the request to generate the device ID; and
computer readable program code configured to transmit the device ID to the mobile wallet application.
